(19) United States
(12) Patent Application Publication
(10) Pub. No.: US 2017/0021315 A1
(43) Pub. Date: Jan. 26, 2017

(54) PADDLE AGITATOR

(71) Applicant: VITA-MIX MANAGEMENT CORPORATION, Olmsted Township, OH (US)

(72) Inventors: Stephen P. Rukavina, Rocky River, OH (US); Joseph M. Hobbs, Olmsted Township, OH (US)

(21) Appl. No.: 15/216,968

(22) Filed: Jul. 22, 2016

Related U.S. Application Data
(60) Provisional application No. 62/195,371, filed on Jul. 22, 2015.

(51) Int. Cl. B01F 7/20; A47J 43/07; A47J 43/044; B01F 7/00

(52) U.S. Cl. CPC B01F 7/20; B01F 7/0005; B01F 7/00116; B01F 7/0015; B01F 7/0025; A47J 43/0711; A47J 43/044; B01F 2215/0026

(57) ABSTRACT

An agitator assembly for mixing a product in a container is provided; the assembly may include a shaft having a distal end and an opposite proximal end. An agitator head may be attached to the distal end of the shaft. The agitator head may include a plurality of paddles extending from a base, wherein at least one of the paddles is made from a flexible material. The agitator head may include four paddles, wherein a first paddle and a second paddle may be generally aligned along a first plane, and a third paddle and a fourth paddle may be generally aligned along a second plane. The first plane may be generally perpendicular to the second plane. The first paddle and the second paddle may include a shape that is generally smaller relative to a shape of the third paddle and the fourth paddle.

### RELATED APPLICATIONS

This application claims the benefit of U.S. Provisional Patent Application Ser. No. 62/195,371, filed Jul. 22, 2015, and entitled “PADDLE AGITATOR,” the entirety of which is incorporated herein by reference.

### FIELD OF THE INVENTION

The present disclosure generally relates to a blender system, and more particularly, to a blender system having an agitator assembly for mixing of foodstuff.

### BACKGROUND

Popular food items are those commonly referred to as “frozen” shakes or drinks, whereby a portion of liquid, and/or a flavored drink mix or syrup, and a portion of ice cream or frozen yogurt may be mixed together in a mixing apparatus or blender to create an almost slush-like drink. In the past, the most typical manner to create such drinks may have required an operator to put a quantity of flavored liquid, ice cream, and possibly other ingredients, such as fruit, candy, nuts and the like, in a cup of an ice cream mixing machine, and, thereafter, operate the machine until the frozen drink is perceived to be adequately mixed. The frozen drink may then be transferred from the cup of the machine to a patron's glass for consumption.

However, as it particularly relates to ice cream, frozen yogurt or other types of high viscous products, many frozen drink mixing machines have trouble reducing the viscosity of the product to allow it to be consumable through a straw. Additionally, many of these machines have trouble mixing in additional treats such as, but not limited to, chunks of candy bars, chocolate bits, sprinkles, pieces of nuts, fruit, candies, cereals, or any other types of additional additives that may be added to a frozen product. Further, another problem facing ice cream type mixing machines that are automated is that they need to be configured to automatically mix product within a wide range of container sizes.

Some traditional mixing agitators require that the user places the cup containing the product underneath a mixing agitator then moves the cup up so the foodstuff is mixed. In some automated machines, the machines move the mixing agitator in an up and down direction relative to the position of the cup containing the product. This up and down movement is in addition to the rotation of the agitator about its center axis to ensure that the product is properly mixed. These automated machines require extra space to house the mechanisms that induce this automated motion. The mechanisms take up space in order to accommodate a stroke range (e.g., range of up/down motion relative to a cup) required to either displace the cup receptacle or translate the agitator for a variety of cup sizes. This usage of space is often undesirable as space in general is at a premium in a restaurant, quick-serve kitchen-type area, or a home countertop. Additionally, machines having additional height can also create challenges for shorter operators who prepare the product.

Current agitators with a fixed vertical stroke length struggle to adequately blend through the entire range of cup sizes for use in these automated machines. Additionally, when the container or agitator translates along a stroke range, the rotating agitator may come into contact with the bottom, walls or lid of the container thereby causing damage to the container.

Further, current agitators may capture a substantial amount of blended product thereon as a result of a mixing cycle. The resulting product loss may be as much as 15% of the final served product. It may take additional time to recapture the product disposed along the agitator, and the act of recapturing the lost product introduces risks related to sanitation. This usually results in the user blending additional product than as required per serving size, which translates into wasted product and lost profit margin.

Many container sizes today have larger vertical profiles and relatively smaller radial profiles. As such, when the container capacity exceeds a particular size, such as for example, 12 to 18 fluid ounces, the performance of traditional agitators is reduced dramatically. Therefore, there is a need for a more efficient design for an agitator assembly that is configured to efficiently mix product in a thorough manner. Additionally, there is a need for an agitator assembly that is configured to mix product in a container made of plastic or other semi-rigid material without damaging the container.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

An agitator assembly for mixing a product in a container is provided; the assembly may include a shaft having a distal end and an opposite proximal end. An agitator head may be operably attached to the distal end of the shaft. The agitator head may include a plurality of paddles extending from a base wherein at least one of the paddles is made from a flexible material. In an aspect, the agitator head may include four paddles wherein a first paddle and a second paddle may be generally aligned along a first plane, and a third paddle and a fourth paddle may be generally aligned along a second plane. The first plane may be generally perpendicular to the second plane and intersect along an axis of rotation. The first paddle and the second paddle may include a common shape that is generally smaller relative to a common shape of the third paddle and the fourth paddle. The first paddle and the second paddle may extend from the base at an angle in a first direction that is generally toward an aperture of the base, and the third paddle and the fourth paddle may extend from the base at an angle in a second direction that is generally away from the aperture of the base.

The base of the agitator head may define a cavity wherein the cavity includes an inner surface having a profile with at least one protrusion receiving portion that is generally aligned at a position where a paddle extends from the base. The distal end of the shaft may include four protrusions wherein two protrusions are generally aligned with a first paddle and a second paddle along the first plane, and two protrusions are generally aligned with a third paddle and a fourth paddle along the second plane.

The first paddle and the second paddle may extend a first radial distance from the axis of rotation. The third paddle and the fourth paddle may extend a second radial distance from the axis of rotation such that the second radial distance is greater than the first radial distance. The first paddle and the second paddle may include a first height at a position adjacent the base. The third paddle and the fourth paddle may include a second height at a position adjacent the base such that the second height is greater than the first height. The first paddle and the second paddle may extend from the base at an axial position that is generally adjacent to the aperture; the third paddle and the fourth paddle extend from the base at an axial position that is generally adjacent to a base end opposite the aperture. The distal end of the shaft may include a plurality of radial protrusions that are aligned within the agitator head for snug attachment therein. The agitator head may be made from a flexible material, for example, an elastomer material.

In one embodiment, provided is an agitator head for an agitator assembly for mixing product in a container, the agitator head may include a base configured to be attached to a shaft. A plurality of paddles extending from the base wherein at least one of the paddles is made from a flexible material.

In another embodiment, provided is a method of mixing a product within a container, the steps include providing an agitator assembly having a shaft and an agitator head with a base and a plurality of paddles extending from the base wherein at least one of the paddles is made from a flexible material. The agitator assembly is inserted within a container having a product to be mixed. The agitator assembly is rotated within the container to mix the product therein such that at least one of the paddles is configured to flex when the paddle abuts against the container. The agitator assembly or the container may be translated relative to the product within the container to sufficiently mix the product.

The following description and the drawings disclose various illustrative aspects. Some improvements and novel aspects may be expressly identified, while others may be apparent from the description and drawings.

### BRIEF DESCRIPTION OF THE DRAWINGS

Objects and advantages together with the operation of the disclosure may be better understood by reference to the following detailed description taken in connection with the following illustrations, wherein:

FIG. 1 is a perspective exploded view of a paddle agitator assembly in an embodiment of the present invention.

FIG. 2 is a side view of the agitator assembly of FIG. 1.

FIG. 3 is a cross-sectional view of the agitator assembly of FIG. 2 through section line A-A.

FIG. 4 is a perspective view of an embodiment of the agitator assembly.

FIG. 5 is an enlarged perspective view of the agitator head of the agitator assembly of FIG. 4.

FIG. 6 is a perspective view of a shaft of the agitator assembly of FIG. 4.

FIG. 7 is a photo of embodiments of an agitator assembly of the present disclosure.

FIG. 8 is a photo of an expanded view of embodiments of an agitator assembly of the present disclosure.

### DETAILED DESCRIPTION

Reference will now be made in detail to exemplary embodiments of the present disclosure, examples of which are illustrated in the accompanying drawings. It is to be understood that other embodiments may be utilized and, structural and functional changes may be made without departing from the respective scope of the disclosure. As such, the following description is presented by way of illustration only and should not limit in any way the various alternatives and modifications that may be made to the illustrated embodiments and still be within the spirit and scope of the disclosure.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

Furthermore, as used herein, the words “coupled,” “attached,” “connect,” and the like are utilized interchangeably unless context suggest otherwise. Such terms may mean removably or irremovably coupled. Furthermore, such terms may mean that articles or components may be or are capable of being coupled together. For instance, “G coupled with H” may mean that G is removably coupled with H, G is irremovably coupled with H, or G is capable of being coupled with H.

It is noted that the various embodiments described herein may include other components and/or functionality. It is further noted that while embodiments may refer to a blender or a blender system, various other systems may be utilized in view of the described embodiments. For example, embodiments may be utilized in food processor systems, spice grinder systems, coffee grinder systems, mixing systems, hand-held blending systems, various other food preparation systems, and the likes. As such, references to a blender, blender system, and the likes, are understood to include food processor systems, and other mixing systems. Such systems generally include a blender base that may include a motor, a blade assembly, and a controller.

Moreover, blending of foodstuff or ingredients may result in a blended product. Such blended products may include drinks, frozen drinks, smoothies, shakes, soups, purees, sorbets, butter (nut), dips or the likes. It is noted that various other blended products may result from blending ingredients. Accordingly, terms such as “blended product” or “drink” may be used interchangeably unless context suggests otherwise or warrants a particular distinction among such terms. Further, such terms are not intended to limit possible blended products and should be viewed as examples of possible blended products.

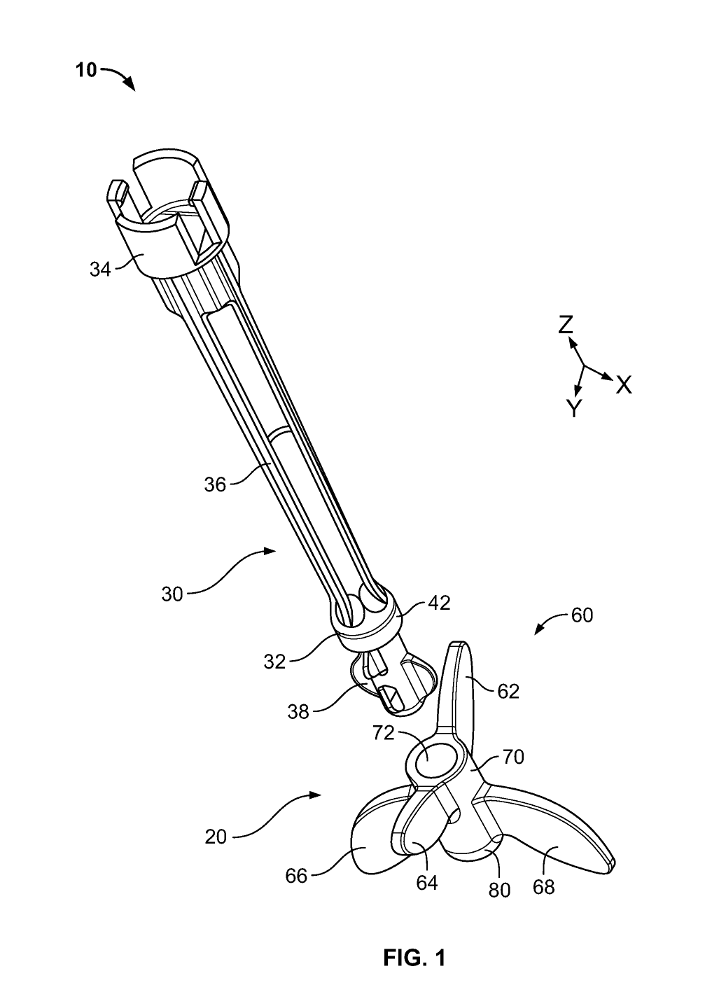

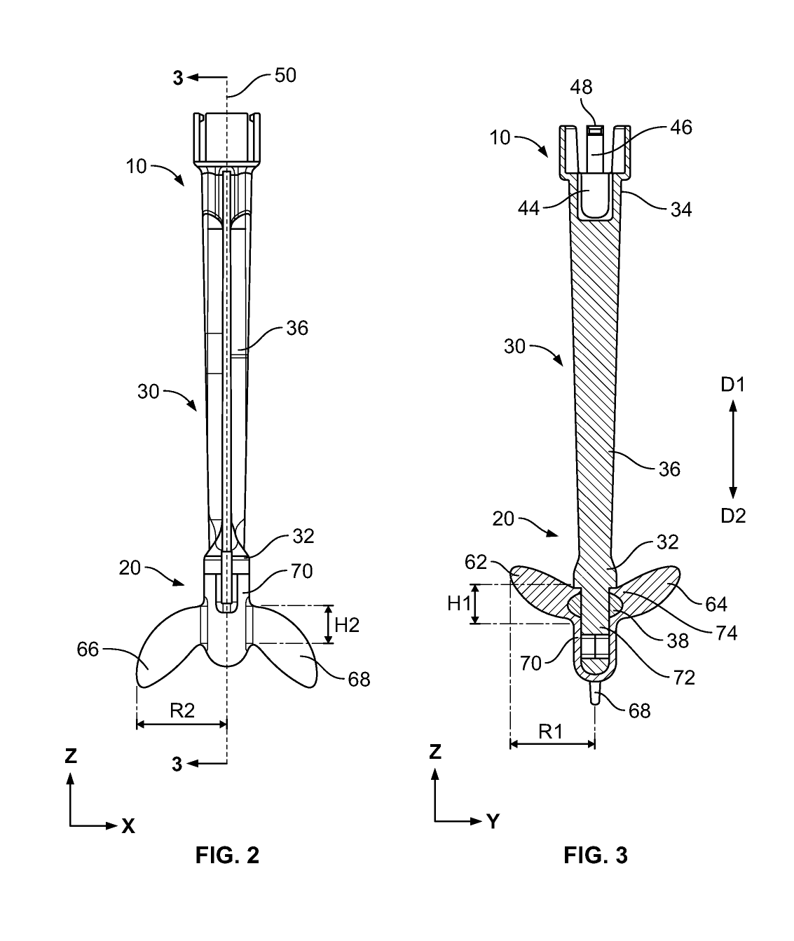

An agitator assembly 10 is illustrated in FIGS. 1-6, and 11. The agitator assembly 10 may include an agitator head 20 having a plurality of paddles 60 extending therefrom. The agitator head 20 may be configured to be attached to a shaft 30. The shaft 30 may be generally elongated and configured to attach to a motor or other rotating mechanism (not shown) capable of rotating the shaft 30 and agitator head 20 about a common axis of rotation 50, such as for example as disclosed in U.S. Patent Application No. 2013/0043337, which is hereby incorporated by reference. The agitator assembly 10 may be of any appropriate shape, size, type or configuration. The agitator assembly 10 may be utilized for any appropriate purpose. For example, the agitator assembly 10 may be utilized to mix a beverage, such as a drink made with a portion of liquid or syrup and a portion of ice cream or frozen yogurt, as may often be prepared and served in restaurants, cocktail lounges, quick-serve kitchens, ice cream parlors, fast food restaurants, at homes, or the like. The agitator assembly 10 may be configured so that rotation of the agitator assembly 10 agitates the product and may precisely control the portions of the drink so as to provide repeated, consistently mixed drinks that may be preferable to be consumed through a straw.

The shaft 30 may have a generally elongated body 36 having a distal end 32 and an opposite proximal end 34. The distal end 32 may be configured to be attached to the agitator head 20 while the proximal end 34 is configured to be attached to a motor or other rotating mechanism not shown). The proximal end 34 may define a cavity 44 and include a pair of resilient arms 46 extending therefrom. The cavity may receive a rotatable shaft 52 (see FIG. 11) that extends from a motor (not shown) to impart selective rotation to the shaft 30 aligned along the axis of rotation 50. The resilient arms 46 may each include a ledge 48 to retain the rotatable shaft 52 within the cavity 44 of the proximal end 34. The distal end 32 may be operably attached to the rotatable shaft 52. However, this disclosure is not limited as to how the proximal end 34 may attach to a rotatable shaft 52 of the motor as other attachments or fasteners are contemplated. For instance, the proximal end 34 may include a threaded portion, channel locks, straps, magnets, or other means for attaching the proximal end 34 to a blender device and/or motor. In at least one embodiment, the rotatable shaft 52 may be attached (e.g., removably or irremovably) with the blender device.

The agitator head 20 may include one or more paddles 60 extending from a base 70. In one embodiment, there are four paddles 62, 64, 66, and 68 that extend from the base 70. The paddles 60 and the base 70 may be made from an elastomer material and include a particular shape and alignment of the paddles 60. The paddles 60 may be formed in a continuous unitary construction with the base 70 or may be separately attached thereto. The base 70 may include an aperture 72 configured to receive the distal end 32 of the shaft 30 and an opposite base end 80. The base end 80 may have a generally rounded orientation, beveled orientation, or the like. The base 70 may define a cavity 74 that is configured to allow the distal end 32 to snuggly attach within the agitator head 20 thereby retarding rotation of the distal end 32 relative to the agitator head 20.

The agitator head 20 and the shaft 30 may be generally aligned along the axis of rotation 50. The distal end 32 may include a plurality of radial protrusions 38 that may be aligned within the agitator head 20 for snug attachment therein. Additionally, the distal end 32 may include a radial edge 42 that abuts against a portion of the base 70 that defines the aperture 72. In one embodiment, the distal end 32 and the body 36 of the shaft 30 may be a generally unitary construction. Alternatively, the distal end 32 may be operatively attached to the body 36 of the shaft 36 such as with a threaded attachment (e.g., 254 of FIG. 11) or other fastener arrangement. In this embodiment, the agitator head 20 and distal end 32 may be operably removed from the body 36 of the shaft 30.

The first paddle 62 and the second paddle 64 may include a generally similar shape. The third paddle 66 and the fourth paddle 68 may include a generally similar shape. The first paddle 62 and the second paddle 64 may define a shape that may be generally aligned along a common plane such as first plane YZ as illustrated by the axis XYZ of FIGS. 1-6. The third paddle 66 and the fourth paddle 68 may define a shape that may be generally aligned along a common plane such as second plane XZ as illustrated by the XYZ axis of FIGS. 1-6. In this embodiment, the Z-axis may be aligned with the axis of rotation 50, the X-axis may be aligned with the third and fourth paddles 66, 68 and the Y-axis may be aligned with the first and second paddles 62, 64.

The first paddle 62 and the second paddle 64 may have a shape that is generally smaller in area and/or volume relative to the shape of the third paddle 66 and the fourth paddle 68. The first plane YZ may be generally perpendicular to the second plane XZ such that the first paddle 62 and the second paddle 64 extend from the base 70 of the agitator head 20 and may be generally perpendicular relative to the third paddle 66 and the fourth paddle 68. The first plane YZ and the second plane XZ may intersect at the axis of rotation 50 such that the paddles 60 are each aligned therefrom. The first paddle 62 and the second paddle 64 may extend from the base 70 at a first incident angle relative to the axis of rotation 50 in a first direction D1 that is generally toward the aperture 72 of the base 70. The third paddle 66 and the fourth paddle 68 may extend from the base 70 at a second incident angle relative to the axis of rotation 50 in a second direction D2 that is generally away from the aperture 72 of the base 70.

In one embodiment, the cavity 72 may include an inner surface having a profile that includes protrusion receiving portions 74 that may be generally aligned at a position within the base 70 where the paddles 60 extend therefrom. For example, as illustrated by cross-section A-A of FIG. 3, the distal end 34 may include four protrusions 38 wherein two protrusions 38 may be generally aligned with first and second paddles 62, 64 along the first plane YZ, and two protrusions 38 may be generally aligned with third and fourth paddles 66, 68 along the second plane XZ.

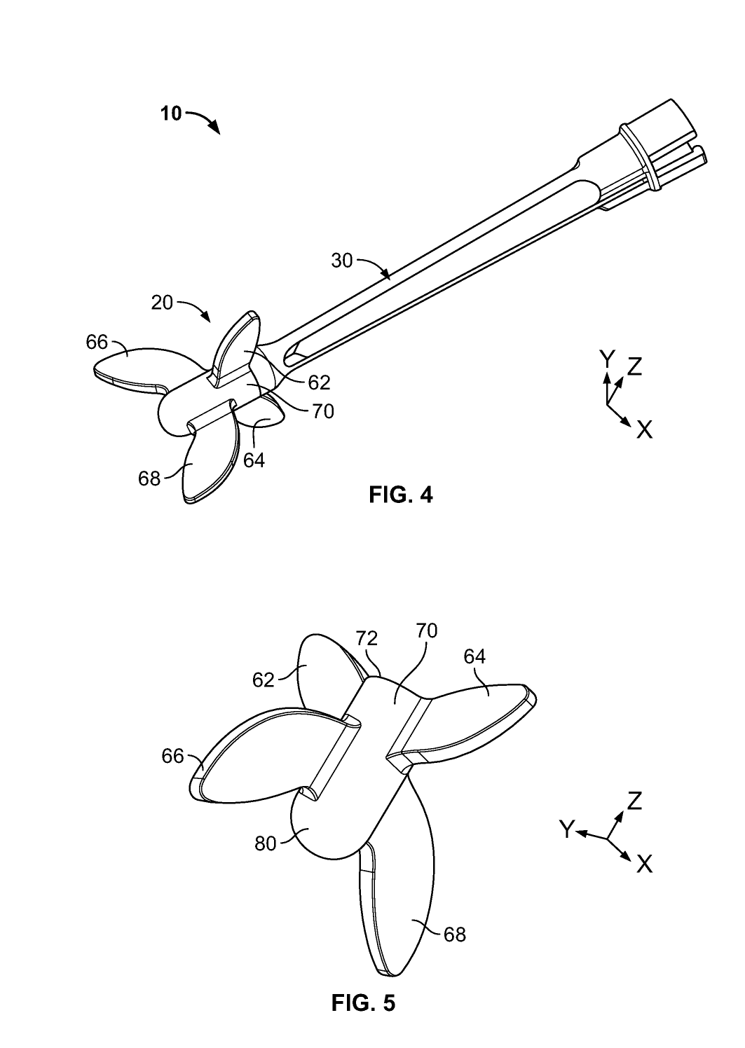

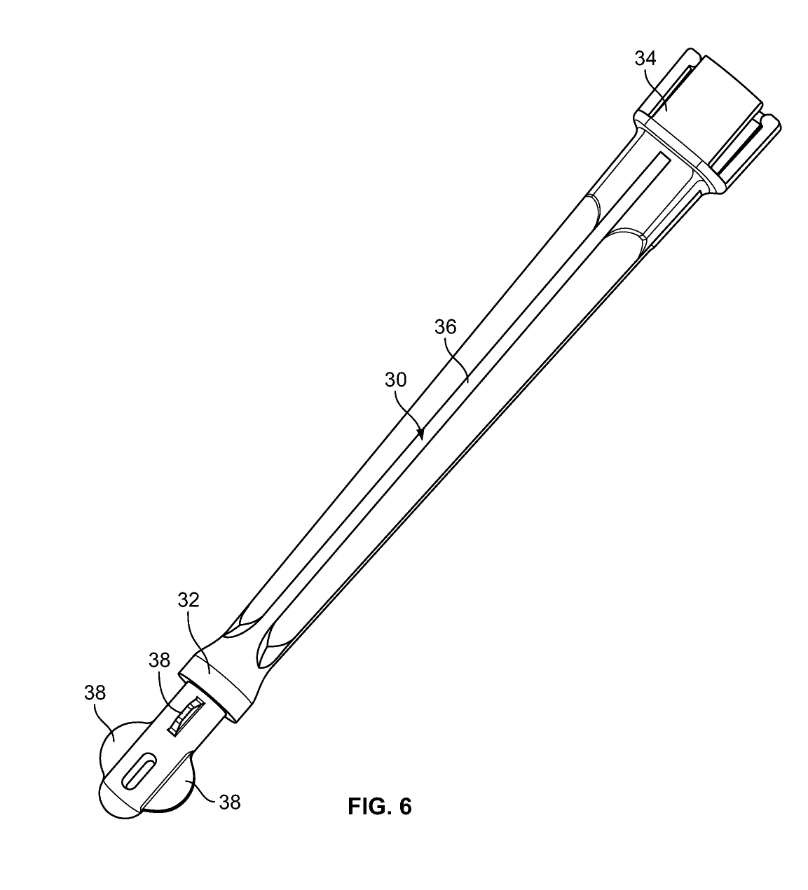

The first paddle 62 and the second paddle 64 may extend a first radial distance R1 from the axis of rotation 50, while the third paddle 66 and the fourth paddle 68 may extend a second radial distance R2 from the axis of rotation 50 such that the second radial distance R2 is greater than the first radial distance R1. The first paddle 62 and the second paddle 64 may include a first height H1 at a position adjacent the base 70. The third paddle 66 and the fourth paddle 68 may include a second height H2 at a position adjacent the base wherein the second height H2 is greater than the first height H1. The first paddle 62 and the second paddle 64 may extend from the base 70 at an axial position that is generally aligned with one another along the Y-axis and generally adjacent to the aperture 72. The third paddle 64 and the fourth paddle 68 may extend from the base 70 at an axial position that is generally aligned with one another along the X-axis and generally adjacent to the base end 80. For example, the third and fourth paddles 66, 68 may be axially spaced a distance that is further from the aperture 72 than the first paddle 62 and second paddle 64. This feature is more clearly illustrated by FIGS. 4 and 5.

The agitator head 20 as described may include a large cross-sectional area when viewed from a line of sight that is generally perpendicular to the axis of rotation 50 relative to a cross-sectional area of the agitator when viewed from a line of sight that is generally parallel to the axis of rotation 50. The paddles 60 may extend from the base 70 wherein the paddles may be made from an elastomeric material wherein it enables the agitator head 20 with a large cross-sectional area to bend if it comes in contact with a mixing container. In an example, a mixing container can comprise a material that may be damaged by a rigid agitator head. For instance, the mixing container may comprise a soft plastic or paper cup. The elastomeric agitator head 20 may mix or blend foodstuff without damaging the mixing container. In some blending systems, users may have to insert a protective liner in these mixing containers and/or may use a separate container other than the container to which a user is served the mixed product.

The flexible paddle feature may be beneficial when the product to be mixed is within a mixing container that is made of a malleable material such as plastic, foam, or other type of material that is sold as a disposable container (not shown). A generally viscous product to be mixed, for example, a combination of ice cream, syrup, whipped cream and other ingredients, may benefit from an agitator head 20 having a relatively large cross-sectional area as it would provide a consistent mix for products in a wide range of container sizes, for example, between about 12-18 fluid ounces, or up to 24 fluid ounces or greater such as 28, 34, 40 or 48 fluid ounces. Contrarily, a radially large cross-sectional agitator made of a rigid material may damage the container sides, bottom, or lid, especially when trying to agitate product within a wide range of container sizes.

It is noted that the agitator head 20 may include a different number of paddles that may comprise different shapes, sizes or orientations. For instance, the agitator head 20 may include three paddles that are each disposed at disparate angles relative to each other and/or body 70. In an example, a first paddle may be disposed at an oblique angle (e.g., as measured along the Z axis), a second paddle may be disposed at an obtuse angle, and a third paddle may be disposed orthogonally to the body 70. In another aspect, paddles may be disposed at angles with respect to other axes, may comprise compound angles or bends, or the like.

Additionally, the described embodiments may optimize blending at a radial perimeter of the mixing container. For example, perimeter mixing may be optimized when blending in a machine that automates the manipulation of the mixing container in relationship to the agitator assembly 10 without the attention of the user. The agitator head 20 with paddles 60 made of a flexible material allows for a high level of flexibility for mixing containers that have relatively large vertical and large radial cross-sections by allowing the paddles 60 to flex when they come in contact with a bottom, sides or lid of the mixing container. This solves the problem of damaging containers while allowing one agitator to provide efficient mixing of viscous product. This disclosure optimizes the cross-sectional area that the agitator may agitate through as well as optimizing the range of container sizes that the agitator may effectively agitate with reduced risk of leakage, mess, or loss of product.

Additionally, the agitator head 20 may include a relatively small cross-sectional size when viewed from a line of sight that is generally parallel to the axis of rotation 50. This small cross-sectional size and general alignment of the paddles 60 may act to reduce the amount of product that may be lost when the agitator head is removed from the mixing container or in comparison to systems that require additional containers or liners. Product waste of other currently known agitators may be as much as 2.5 fluid ounces. However, the flexible paddle agitator may waste less than about 0.9 oz. (weight) or more particularly, 0.5 oz. while effectively blending product within containers that range between about 12 fluid ounces to about 24 fluid ounces.

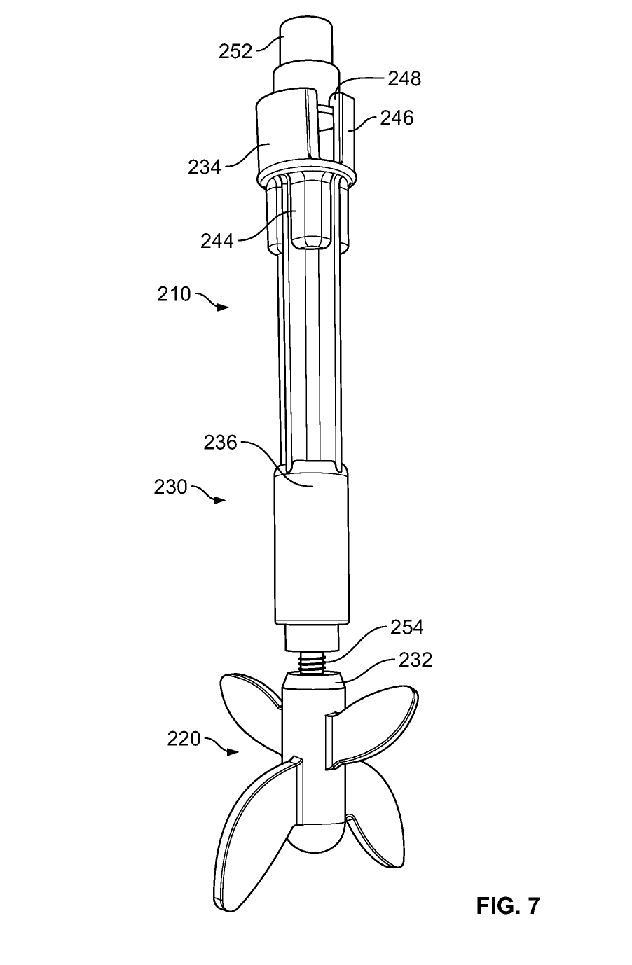

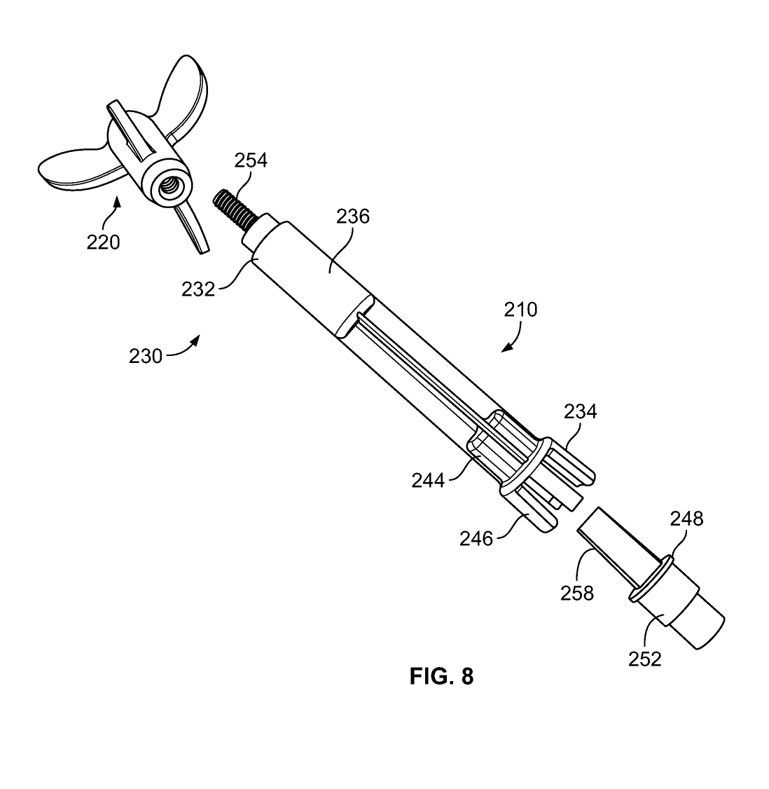

FIGS. 7 and 8 illustrate an embodiment of an agitator assembly 210. As depicted, the agitator assembly 210 may primarily include shaft 230, agitator head 220, and rotatable shaft 252. In an aspect, a distal end 232 of shaft 230 may comprise a threaded attachment 254. The threaded attachment 254 may be received by an appropriate threaded portion of the agitator head 220. As described here as well as elsewhere in this disclosure, the agitator head 220 and the body 236 may be attached via a variety of methods and/or means. For instance, threaded attachment 254 may be a female threaded attachment to which a male attachment member of agitator head 220 may attach.

In at least one embodiment, the shaft 230 may be configured to attach to a variety of different agitator heads or other components. For instance, the agitator head 220 may be removed or detached from the shaft 230, and a metallic agitator head may be attached to the shaft 230. In another aspect, the agitator head 220 may be removed for cleaning of various components.

Distal end 234 of shaft 230 may comprise one or more resilient arms 246 and a cavity 244. The cavity 244 and resilient arms 246 may be configured to receive a rotatable shaft 252. For instance, an attachment member 258 may be inserted in the cavity 244. A flange or ledge 248 may be secured by a cleat or ledge of the resilient arms 246. In at least one embodiment, a user may press the rotatable shaft 252 into the cavity 244, and the resilient arms 246 may be manipulated to snap around the ledge 248. It is noted that the rotatable shaft 252 may be attached to the shaft 230 by other means and/or may be monolithically formed with and/or irremovably attached to the shaft 230.

Although the embodiments of the present disclosure have been illustrated in the accompanying drawings and described in the foregoing detailed description, it is to be understood that the present disclosure is not to be limited to the embodiments disclosed, but that the disclosure described herein is capable of numerous rearrangements, modifications and substitutions without departing from the scope of the claims hereafter.

Having thus described the invention, the following is claimed:

1. An agitator assembly for mixing a product in a container, the assembly comprising:
a shaft having a distal end and an opposite proximal end; and
an agitator head attached to the distal end of the shaft, the agitator head including a plurality of paddles extending from a base wherein at least one of the paddles is made from a flexible material.

2. The agitator assembly of claim 1, wherein the agitator head includes four paddles.

3. The agitator assembly of claim 1, wherein the agitator head includes a first paddle and second paddle generally aligned along a first plane, and a third paddle and a fourth paddle generally aligned along a second plane.

4. The agitator assembly of claim 3, wherein the first plane is generally perpendicular to the second plane.

5. The agitator assembly of claim 3, wherein the first paddle and the second paddle include a shape that is generally smaller relative to a shape of the third paddle and the fourth paddle.

6. The agitator assembly of claim 3, wherein the first paddle and the second paddle extend from the base at an angle in a first direction that is generally toward an aperture of the base, and the third paddle and the fourth paddle extend from the base at an angle in a second direction that is generally away from the aperture of the base.

7. The agitator assembly of claim 1, wherein the agitator head includes a base that defines a cavity wherein the cavity includes an inner surface having a profile with at least one protrusion receiving portion that is generally aligned at a position along the base where a paddle extends therefrom.

8. The agitator assembly of claim 7, wherein the distal end includes four protrusions wherein two protrusions are generally aligned with a first paddle and a second paddle along a first plane, and two protrusions are generally aligned with a third paddle and a fourth paddle along a second plane.

9. The agitator assembly of claim 3, wherein the first paddle and the second paddle extend a first radial distance from an axis of rotation, a third paddle and a fourth paddle extend a second radial distance from the axis of rotation such that the second radial distance is greater than the first radial distance.

10. The agitator assembly of claim 3, wherein the first paddle and the second paddle include a first height, the third paddle and the fourth paddle include a second height such that the second height is greater than the first height.

11. The agitator assembly of claim 3, wherein the first paddle and the second paddle extend from the base at an axial position that is generally adjacent to the aperture, the third paddle and the fourth paddle extend from the base at an axial position that is generally adjacent to a base end opposite the aperture.

12. The agitator assembly of claim 1, wherein the agitator head and the shaft are generally aligned along an axis of rotation.

13. The agitator assembly of claim 1, wherein the distal end of the shaft includes a plurality of radial protrusions that are aligned within the agitator head for snug attachment therein.

14. The agitator assembly of claim 1, wherein the agitator head is made from a flexible material.

15. An agitator head for an agitator assembly for mixing product in a container, the agitator head comprising:
a base configured to be attached to a shaft; and
a plurality of paddles extending from the base, wherein at least one of the paddles is made from a flexible material.

16. An agitator assembly for a blender system, the agitator assembly comprising:
a shaft operatively attachable to a drive shaft of the blender system;
an agitator head comprising a base and a plurality of paddles extending from the base, wherein at least one of the paddles comprises a flexible material.

17. The agitator assembly of claim 16, wherein the agitator head is removably attached to the shaft.

18. The agitator assembly of claim 16, wherein the flexible material comprises a rubber.

19. A blender system comprising:
a blender comprising a motor;
an agitator assembly operatively attachable to a drive shaft of the blender, wherein the agitator comprises an arm and an agitator head disposed at a distal head of the arm, and
wherein the agitator head comprises one or more flexible paddles.

20. The blender system of claim 19, wherein the one or more flexible paddles comprise a first flexible paddle extending from the agitator head at a first angle, and a second flexible paddle extending from the agitator head at a second angle.
